(19) United States
(12) Patent Application Publication
(10) Pub. No.: US 2003/0018736 A1
(43) Pub. Date: Jan. 23, 2003

(54) System for the acquisition and information of regionally grouped, up-to-date medical data

(76) Inventors: Tilo Christ, Erlangen (DE); Volker Schmidt, Erlangen (DE); Siegfried Schneider, Erlangen (DE); Hans-Dieter Schuell, Weisendorf (DE); Werner Striebel, Schwarzenbruck (DE)

Correspondence Address: SCHIFF HARDIN & WAITE, 6600 SEARS TOWER, 233 S WACKER DR, CHICAGO, IL, 60606-6473, US

(21) Appl. No.: 10/154,001

(22) Filed: May 23, 2002

(30) Foreign Application Priority Data
May 23, 2001 (DE) 10125543.8

(51) Int. Cl. G06F 15/167

(52) U.S. Cl. 709/212

(57) ABSTRACT

A system for the acquisition and evaluation of regionally grouped, up-to-date medical data has devices for the acquisition of the medical data, devices for the transmission of the medical data to a system center, an evaluation device for the medical data, devices for interrogating the evaluated, medical data, and devices for the transmission of the evaluated, medical data from the system center. The system center has a memory for the acquired medical data and reference values for the medical data, and the evaluation device includes a comparator for comparing the medical data to the stored reference values to produce an evaluation result.

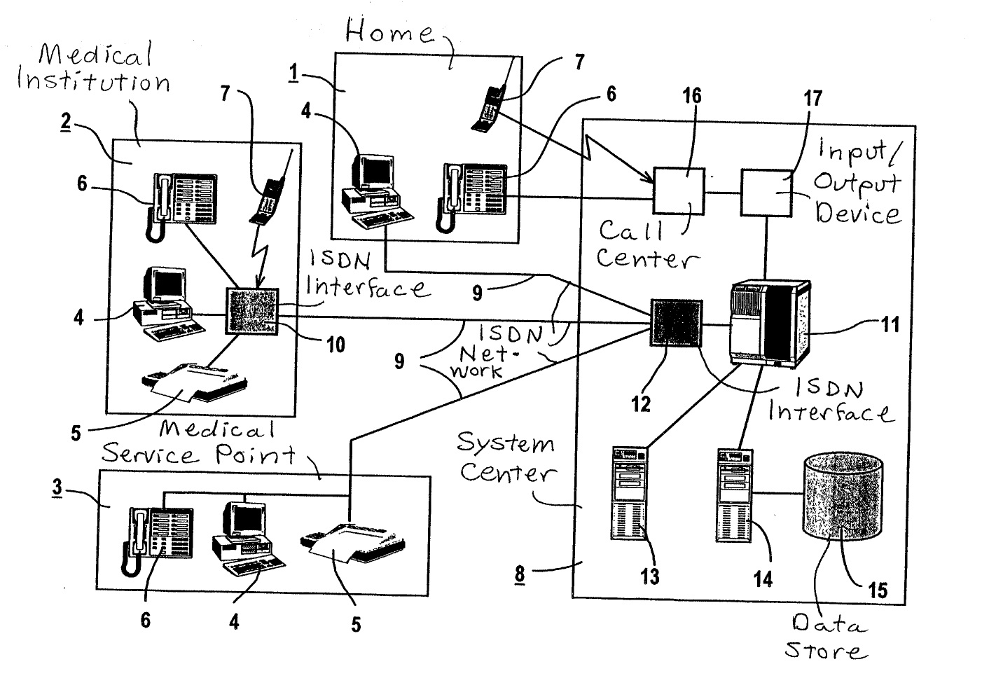

### BACKGROUND OF THE INVENTION

1. Field of the Invention

The present invention is directed to a system for the acquisition and information of regionally grouped medical data with an evaluation device. Such a system serves as information service about the regionally grouped, up-to-date frequency of occurrence and distribution of infectious diseases.

2. Description of the Prior Art

Medical expert systems that operate based on an analysis of probabilities are known. In such probability-based expert systems, a parameterization ensues, for example, via statistical data that, for example were acquired in the framework of a study. Such data do not reflect any current situations and they are permanently implemented in the data modules. As a consequence, such expert systems can be utilized only in areas wherein it is justifiable to expect stability of the data over time.

German OS 199 30 250 discloses an apparatus for monitoring data, particularly from an electro-medical implant, obtained by transmission of the data from an implanted medical-electronic device of an individual patient via a mobile radio telephone network.

U.S. Pat. No. 5,841,975 discloses a system for the implementation of laboratory tests in a distributed system, for the purpose of producing a diagnosis.

### SUMMARY OF THE INVENTION

An object of the present invention is to provide an expert system of the species initially cited that collects current, real statistical data for correct conclusions in a simple way.

This object is inventively achieved in a system having devices for the acquisition of medical data, devices for the transmission of the medical data to a system center, an evaluation device for the medical data, having devices for interrogating the evaluated, medical data, and devices for the transmission of the evaluated, medical data from the system center, whereby the system center has a memory for the acquired medical data and reference values for the medical data, and the evaluation device has a comparator for comparing the medical data to the stored reference values.

By “erecting” many acquisition points, current data can be acquired for epidemiological cartographies and can be processed. As a result of this system, a simple and economical support is obtained for, for example, citizens and physicians in a region such as, for example, an urban neighborhood, a city, a county or a region with respect to information about the current spread of infectious diseases and, accordingly, allows measures to be initiated for the reduction and localization thereof.

The medical data are epidemiological, current data such as, for example, the presence of a measles epidemic within a region. Current disease conditions are locally acquired via a distributed input and interrogation program for medical data and current epidemiological maps are calculated therefrom. When an inquiry arises, for example as to what the current frequency of measles in a region is, the system supplies this value. The evaluation device can be an expert system configured with such statistical data, so that it can allow current knowledge as well as regional accumulations to enter into the inquiry results.

Inventively, the devices for acquiring the medical data can be arranged in the home of, for example, a patient, in institutions and/or at medical service points.

A simple acquisition is achieved when the apparatus for acquiring the medical data and/or the evaluated data communicate with the system center via the Internet (WWW). It has thereby proven advantageous for the medical expert systems to be automatically configured via the data from the Internet.

Nearly anyone can acquire and interrogate the data when the devices for the acquisition of the medical data and/or of the evaluated data communicate with the system center, for example with a call center, via a telephone.

### DESCRIPTION OF THE DRAWINGS

The single FIGURE is a schematic illustration showing the components and interrelated communication paths of a system for acquiring and evaluating regionally grouped, up-to-date medical data, constructed and operating in accordance with the principles of the present invention.

### DESCRIPTION OF THE PREFERRED EMBODIMENTS

The FIGURE shows an inventive system for acquiring and evaluating regionally grouped, up-to-date medical data. The patient at home 1, institutions 2 such as, for example, school, kindergarten, employer or the like, as well as medical service points 3 such as, for example, a physician, a pharmacist or a hospital, can serve for the acquisition of the medical data.

The up-to-date data can be forwarded to a system center 8 as current, a priori probabilities. The data can be forwarded directly by a personal computer 4, by fax machine 5 or by telephone 6 or cell phone 7. This can ensue, for example, via an ISDN network 9 to which the corresponding terminal devices are connected either directly or via an ISDN interface 10.

A gateway 11 that is connected to the ISDN network 9 via an ISDN interface 12 is provided in the system center 8. An Internet proxy server 13 can be connected to the gateway 11 for access onto the Internet and an evaluation device 14 with a data store 15 for the up-to-date data can also be connected thereto.

The data forwarded to the system center 8, for example by telephone 6 or cell phone 7, can be accepted by a call center 16 and can be entered into the system by an input and output device and can be in turn called therefrom in the same way.

The evaluation device 14 includes, for example, a comparator for comparing the data to reference values stored in the data store 15 and an alarm device for notifying selected recipients when the measured values upwardly exceed stored reference value limits.

Reception devices such as, for example, a fax machine 5, a personal computer 4, a telephone 6 or a cell phone 7 are connected to the system center 8 for up-to-date interrogation of the evaluating, medical data.

In the system center 8, the medical data are read in via standardized telecommunication interfaces and are stored long-term in the data store 15. The evaluation device 14 evaluates the medical data and the point-in-time of the data transmission in order to be able to automatically send information messages. The data transmission ensues, for example, via the Internet or telephone network.

The evaluation device 12 judges whether the frequency and distribution of the data are to be classified as representing abnormal conditions. Empirically determined limits (reference values) that are stored in the data store 15 are used as criteria.

Analogous to regional weather services, current traffic reports or air-borne pollen reports, the acquisition and forwarding of information about the current spread of infectious diseases such as, for example, influenza, flu-like infections, stomach flu, hepatitis, children's diseases such as measles, mumps, rubella, chicken pox, whooping cough, scarlet fever, diphtheria, three-day fever, etc., can be acquired and referenced any time. As a result of the evaluation based on comparison of the acquired data, a finding can be made as to whether this is a matter of individual cases or of an epidemic.

The acquisition ensues directly by means of the affected patients or family members, for example the parents, the attending physicians, pharmacies or other responsible parties such as, for example, school administration, employer, etc. The users of the service can interrogate the current frequency and distribution via the Internet, by telephone, fax poling, picture screen text or other communication mechanisms for a specific region or for a number of regions. Users of the service are the aforementioned groups and, as warranted, further persons or entities that require regionally grouped, up-to-date or statistical numbers.

The inventive system has the following advantages:

The decentralized data acquisition ensues in a broadly scattered, regionally grouped and economical manner.

The up-to-date data can be entered as current, a priori probabilities in on-going operation, into the medical expert system; so the system is automatically adapted to the current situations.

The medical data can be communicated to the system center

from the patient

via reports of diseases to institutions such as, for example, school, kindergarten, employer or the like, as well as

from medical service points such as, for example, physician, apothecary or hospital,

whereby, for example, the Internet (WWW) or telephone (call center 16) can be utilized.

The evaluated medical data can be used in a versatile way. For example, the data can serve for

Assisting the diagnosis for attending physicians;

Assisting prevention for patients;

Automatic employment as distribution probabilities in expert systems;

Forwarding accumulated data for statistical or scientific purposes (epidemiology);

Supporting marketing and logistics of the pharmaceutical industry; and

A commercially available service for regional media such as, for example, newspapers, radio or television.

The inventive system serves as an information system for regionally grouped, up-to-date medical data about frequency and distribution of infectious diseases. Optionally, this information service can be used for parameterization of medical expert systems with current probabilities.

Although modifications and changes may be suggested by those skilled in the art, it is the intention of the inventors to embody within the patent warranted hereon all changes and modifications as reasonably and properly come within the scope of their contribution to the art.

We claim as our invention:

1. A system for acquiring and evaluating regionally grouped, up-to-date medical data, comprising:
a plurality of data acquisition components for acquiring medical data from respective subjects;
a system center located remote from said data acquisition components;
a plurality of transmission devices for respectively transmitting said medical data from said data acquisition components to said system center;
an evaluation unit located at said system center for evaluating the medical data transmitted to said system center from said data acquisition devices to obtain an evaluation result;
a memory accessible by said evaluation unit in which said medical data are stored and in which reference values for said medical data also are stored;
said evaluation unit including a comparator for comparing said medical data and said reference values stored in said memory to obtain said evaluation result; and
a system center transmission unit for transmitting said evaluation result to a location remote from said system center.

2. A system as claimed in claim 1 wherein said evaluation unit comprises an expert system.

3. A system as claimed in claim 1 wherein at least one of said data acquisition components comprises a component for acquiring said medical data at a home of a subject.

4. A system as claimed in claim 1 wherein at least one of said data acquisition components comprises a component for acquiring said medical data at a medical institution.

5. A system as claimed in claim 1 wherein at least one of said data acquisition components comprises a component for acquiring said medical data at a medical service point.

6. A system as claimed in claim 1 wherein said communication devices communicate between said data acquisition components and said system center via the Internet.

7. A system as claimed in claim 6 wherein said evaluation unit comprises an expert system that is automatically configured by data from the Internet.

8. A system as claimed in claim 1 wherein at least one of said communication devices is a telephone.

9. A system as claimed in claim 1 wherein said communication devices include a call-in center, accessible by said telephone, and having a communication path to said evaluation unit for supplying said medical data from said telephone to said evaluation unit.
